(19) United States
(12) Patent Application Publication
(10) Pub. No.: US 2007/0107396 A1
(43) Pub. Date: May 17, 2007

(54) Method and apparatus for a gas-liquid separator

(76) Inventor: Bilal Zuberi, Cambridge, MA (US)

Correspondence Address: GEO2 TECHNOLOGIES, 12-R CABOT ROAD, WOBURN, MA, 01801, US

(21) Appl. No.: 11/468,166

(22) Filed: Aug. 29, 2006

Related U.S. Application Data
(63) Continuation-in-part of application No. 11/322,777, filed on Dec. 30, 2005.
(60) Provisional application No. 60/737,237, filed on Nov. 16, 2005.

(51) Int. Cl. B01D 39/20; B01D 50/00; B01D 53/34

(52) U.S. Cl. 55/523; 422/177

(57) ABSTRACT

A porous ceramic substrate is provided for coalescing and trapping particulate, including liquid, in a gas stream. The porous ceramic substrate is composed essentially of fibrous ceramic material, with bonded fibers that create a network of interconnected pores. A variety of fibers can be used, with a range of fiber diameters, to provide efficient coalescing of particulates in a gas stream. Oil droplets are trapped and coalesced by the porous ceramic substrate, that are collected and thus, separated from the gas stream. Filtered gas is directed out of the filter, while the collected particulates are received in a collection area. The porous ceramic substrate composed of essentially fibrous ceramic material can be configured in a honeycomb configuration with channels that provide an inlet channel and/or an outlet channel. Wall flow configurations can be provided to direct the flow of the gas stream through the porous ceramic material from an inlet channel into an outlet channel.

### RELATED APPLICATIONS

This application is a continuation-in-part of U.S. patent application Ser. No. 11/322,777, filed Dec. 30, 2005, entitled “Process for Extruding a Porous Substrate”, which claims priority to U.S. provisional patent application Ser. No. 60/737,237, filed Nov. 16, 2005, and entitled “System for Extruding a Porous Substrate”; both of which are incorporated by reference herein in their entirety.

### BACKGROUND

The present invention relates generally to a device for separating a liquid from a gas, and in one example, to an air-oil separator using a ceramic honeycomb structure for effecting the separation.

### DESCRIPTION OF RELATED ART

A liquid-gas separator is used in many industrial, commercial, and residential applications. Other applications may exist in other fields such as in military applications. A liquid gas separator is typically attached to an exhaust line for removing a liquid content from a gas. In one particular example, a gas liquid separator may be an air oil separator. An air oil separator may advantageously be used on internal combustion engines for removing oil from the crank case vent system, or may be used on other industrial equipment such as compressors for removing oil mist from a compressed air stream. In the case of air-oil filtration system for compressors, a coalescence filter can be used as a first stage filter with a trapping filter as a second stage. Smaller droplets, such as fine mist of diameters from 10 nm -10 microns, are trapped onto the first stage filter element, where they coalesce to form larger droplets and then any large droplets that escape from the first stage filter are trapped with a second stage filter.

To facilitate description of the liquid gas separator, this application will describe in detail an air oil separator, although other implementations may be used. In one example, an air oil separator is used on internal combustion engines for removing oil from a crank case ventilation system. In an internal combustion engine, the exhaust from the crank case vent may account for 10% to 40% of particulate exhaust or other VOC or noxious emission. Accordingly, it is important for environmental considerations to effectively remove oil or other particular matter from crank case vent exhausts for reducing oil consumption, for environmental concerns as well as for performance and durability of other engine components, such as turbo and inter-coolers. In engine design, two considerations drive the design and implementation of the crank case vents filters. First, the crank case vent filter must be able to sufficiently clean the exhaust according to environmental requirements. This is especially necessary for open crank case filters where the crank case emissions are vented to the environment, however, in the case of closed crank case ventilation, trapping of oil and other debris, including soot and fine dust, is equally important to prevent engine component wear downstream. Second, the filter needs to be as small as possible, as space is at a premium in the design of current engine systems. However, these design considerations are in conflict. For example, a filter system which removes a large quantity of oil and particulate may have to be large (in order to last a long enough period before needing a replacement or regeneration) , or if the filter is made compact, it may generate an unacceptable back pressure to the engine or may not trap sufficiently.

In current designs, a crank case filter may be a mesh filter made out of metal gauze. Such a filter is quite coarse, and relatively ineffective for removal of oil or particulate matter. Due to the ineffectiveness of such mesh filters, newer filters have been developed using a fiberglass filter. Here, the fiberglass is a term used to broadly classify filters made of fiber-based papers, where the fibers can constitute a variety of plastic, polymeric, ceramic or metal compositions. Sometimes these fiberglass filters are complimented by a secondary stage filter which may be made of a metal wire mesh. These fiberglass filters have fiberglass matting, in paper form wrapped multiple times around a central cylinder, for coalescing oil, as well as for trapping some particulate matter. In some cases, very thin diameter fibers are deployed, such as nano-fibers (made of fibers with diameters from 50 nm to 1000 nm). However, these nano-fiber filters are typically expensive, present a risk of secondary emissions of nanofiber particles, and produce higher backpressures. Consequently, standard fiberglass filters (wrapped or pleated paper honeycomb) must be relatively large to adequately filter exhaust gas, and are subject to easy clogging and high backpressures. Developments are occurring in the field of new fiber chemistries and fiber diameters, in order to better trap and coalesce the liquid media in a fluid stream, but the basic geometry, form, and structure of the filters remains a problem. However, none of the fibrous systems in the mat, i.e., paper wrapped around a central spindle, or pleated in the form of a honeycomb, or pleated in the form of a donut design, have provided adequate filtration in the desired filter size range. Accordingly, the industry has attempted to use non-fiber based techniques to separate air and oil from an admixture of the components. An example of such a technique is electrostatic precipitation. An electrostatic precipitator requires external power for separating oil from the air, and provides acceptable filtration and oil removal results. Further, electrostatic precipitator may be made very small, so is advantageously used in space-constrained designs. However, the electrostatic precipitator is very expensive, and requires external power and external control systems, complicating the integration of electrostatic precipitator into existing engine systems. Other exotic systems, such as centrifuge systems, may also be used in highly specialized applications, but do not provide cost-effective filtration for mass production. Accordingly, all known technologies suffer either from inadequate filtration, excessive back pressure, excessive size, or excessive of cost. Therefore, there exists a need for a cost-effective filter that may be compactly implemented, and still provide effective and efficient air oil separation.

### SUMMARY OF THE INVENTION

The present invention provides an inexpensive and efficient filter for the separation of gas and oil to trap and coalesce liquid and particulate matter in a fluid stream. The filter of the present invention is composed of bonded fibers in a porous ceramic substrate housed within a housing. The housing provides an inlet for a mixture of gas and liquid, and an outlet for the gas that has been filtered by the porous ceramic substrate. A liquid collection area receives the liquid that has been coalesced from within the porous substrate. In an embodiment of the invention, the porous substrate has channels that form a honeycomb configuration. The honeycomb substrate can be provided in a wall-flow configuration with a set of inlet channels and outlet channels arranged in an alternating pattern.

In a more specific example, the air-oil separator of the present invention is used in a crank case ventilation system. In this embodiment, the porous ceramic substrate is mounted in a housing that is connected to a crank case vent on an engine. The system has an inlet connecting the crank case vent to the filter with an exhaust line for the filtered vent gas and an oil return line for the oil that has been coalesced and collected by the filter. In another embodiment, a second stage filter can be used to collect coalesced oil droplets that pass through the filter into the exhaust stream. These escaped particles can be easily trapped and collected by conventional pleated paper, or fiberglass filters.

These and other features of the present invention will become apparent from a reading of the following description, and may be realized by means of the instrumentalities and combinations particularly pointed out in the appended claims.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a diagram of an air-oil separator in accordance with the present invention.

FIG. 2 is a diagram of a honeycomb substrate for an air-oil separator in accordance with the present invention.

FIG. 3 is a diagram of a ventilation system using an air-oil separator in accordance with the present invention.

FIG. 4 is a flowchart of a process of using of an air-oil separator in accordance with the present invention.

FIG. 5 is a flowchart of a process of using of an air-oil separator in accordance with the present invention.

FIG. 6 is an enlarged illustration of an oil coalescence using an air-oil separator in accordance with the present invention.

FIG. 7 is a diagram of a ventilation system using an air-oil separator in accordance with the present invention.

FIG. 8 is a diagram of a ventilation system using an air-oil separator in accordance with the present invention.

FIG. 9 is a diagram of an air-oil separator in accordance with the present invention.

FIG. 10 is a diagram of an air compressor system using an air-oil separator in accordance with the present invention.

FIG. 11 is a flowchart of a process using an air compressor system having an air-oil separator in accordance with the present invention.

FIG. 12 is a diagram showing the alumina-silica phase relationship.

### DETAILED DESCRIPTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

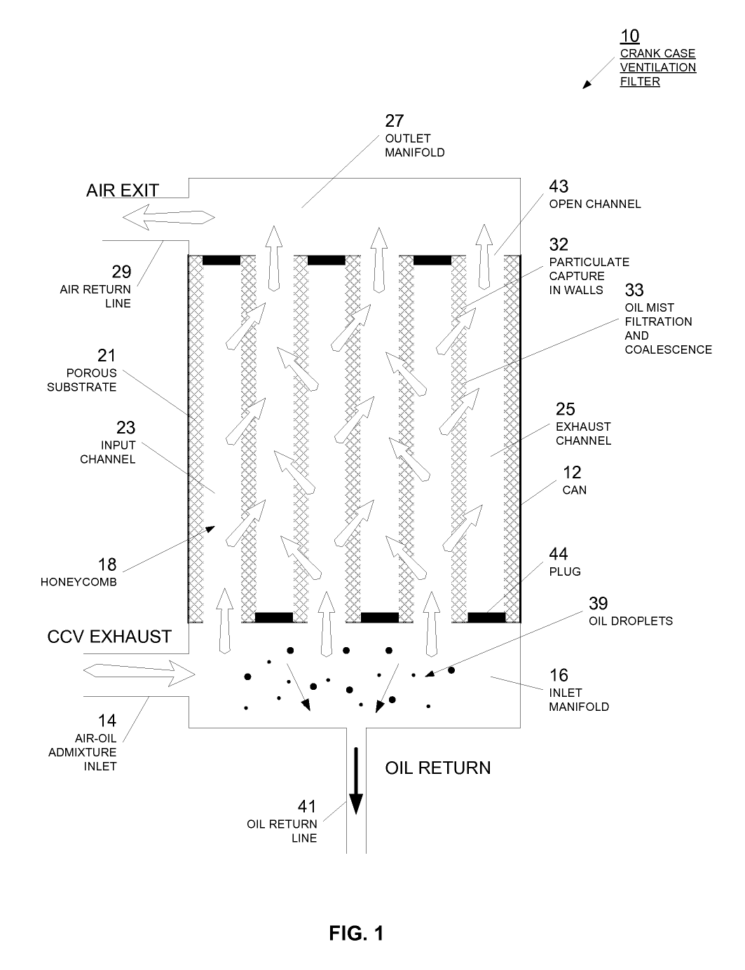

Referring now to FIG. 1, a gas-liquid filter is illustrated. The gas-liquid filter is illustrated as a crank case ventilation filter 10 for separating oil from a gas exhausted from the crank case of an engine. One skilled in the art will appreciate that while the illustrative embodiment of FIG. 1 is directed toward a crank case ventilation of an internal combustion engine, such as a diesel or gasoline engine, the filter 10 can be used for a variety of gas-liquid separation applications, such as, for example, in an air compressor. Crank case ventilation filter 10 is intended to be installed with an internal combustion engine, and more particularly connected to the crank case ventilation output port. Filter 10 has a can 12 for holding the filter substrate 21 and for mechanically positioning the filter 10. The can 12 has an air oil admixture inlet 14 for receiving a mixture of exhaust air and oil being exhausted from the crank case event. As used herein, the term “admixture” generally describes a mixture of gases, solids, and/or liquids. It is understood that the oil may also contain other impurities such as ash particulates, unburned hydrocarbons, soot particles, dust particles, etc. The air oil admixture is received into an inlet manifold 16 which distributes and routes the air oil admixture into a set of input channels 23. It will be appreciated that more complex manifold arrangements may be used. The input channels are formed in a porous substrate 21. The porous substrate 21 may, in one example, be formed in the shape of a honeycomb. The honeycomb porous substrate may be a ceramic fiber substrate as described in co-pending patent application Ser. No. 11/322,777, herein incorporated by reference. It will be appreciated that other porous honeycomb filters may be used, including those extruded as a single monolithic substrate, or segmented by the fabrication of a plurality of honeycomb substrate sections into a single substrate.

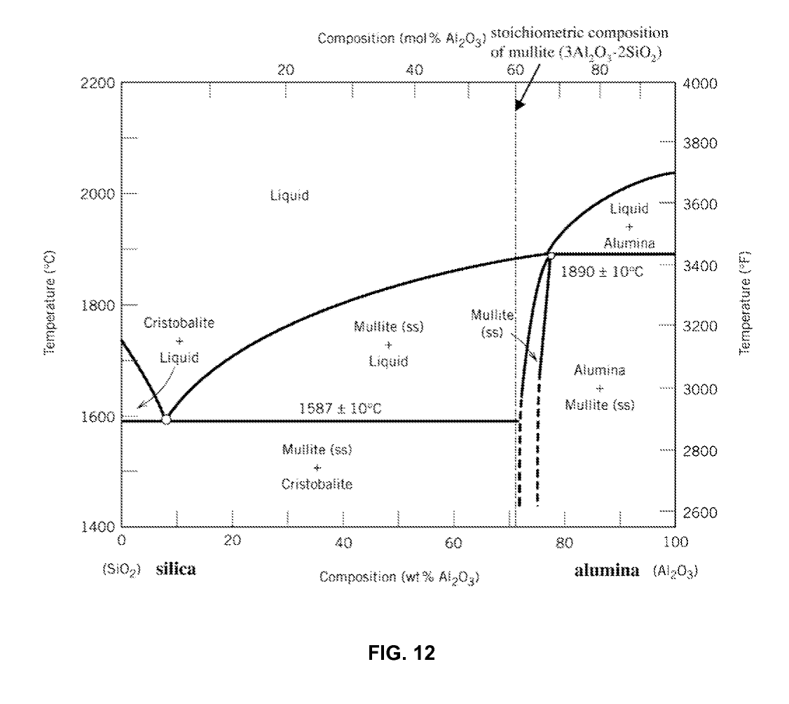

In an exemplary embodiment the honeycomb porous substrate is composed of mullite fibers having a porosity of about 85%. Mullite is the mineralogical name given to the only chemically stable intermediate phase in the Al₂O₃ —SiO₂ system. The natural mineral is rare, naturally occurring on the Isle of Mull off the west coast of Scotland. Mullite is commonly denoted as 3Al₂O₃.2SiO₂(i.e., 60 mol % Al₂O₃ and 40 mol % SiO₂), though mullite fibers, in this exemplary embodiment, can include a metastable phase of 2Al₂O₃.SiO₂ or compositions from 60 mol % to 67 mol % alumina. An alumina-silica phase diagram showing the mullite composition is shown as FIG. 12.

The porosity of the porous substrate can range between 50% and 85% depending upon the selection of fiber characteristics and additives. In other embodiments, the material of the porous substrate can be fiberglass (i.e., silica-based material). Alternative fiber compositions, including alumina-zirconia-silica can alternatively be used. The fibers can have diameters that characterize the fibers as microfibers, with diameter larger than 0.2 microns but not larger than 10 microns. Alternatively, the fiber can be characterized as nanofibers, with a diameter less than about 0.2 micron. In an embodiment, the fiber diameter is in the range of 0.05 microns to about 100 microns. In another embodiment, the fiber diameter is 1 micron to about 25 microns. In still other embodiments, the porous honeycomb substrate can be composed of a mixture of fiber materials and/or of varying diameters, to form a composite porous substrate. The two fiber materials and/or fiber materials having varying diameters can be mixed or they can be layered as a gradient substrate. Substrates or portions of substrates composed of nanofibers have a high trapping efficiency for the smallest drops, which result in effective coalescing. However, a substrate composed essentially of nanofibers may exceed backpressure requirements. By mixing the fibers of varying materials and/or diameters, or by layering the two types of fibers, the nanofiber portion performs effective coalescing, while the larger diameter fibers or material traps larger particles, or coalesced material, without increasing backpressure in the flow or stream.

The admixture is received in to the set of input channels, and the gas and oil mixture is forced through walls in the channels. In this way, air from an input channel 23 is routed into an exhaust channel 25. As the air oil mixture passes through the porous walls, oil is trapped onto the fibers in the filter, coalescing from small droplets and mist to form larger droplets in the wall 33 and falls as oil droplets 39 into an oil collection area 41. As gas passes through the wall, particulate matter in the gas is also captured in the porous ceramic wall 32. The filtered gas then exits the open channels 43 into an output manifold. 27, and passes through an air return line 29. The air return line may couple to a turbocharger, to an air input for the engine, or may be exhausted to the atmosphere. In another example, the air exit couples to a second stage filter. This may be advantageous as a single air oil filter may not sufficiently remove enough oil or particulate matter from the air oil admixture. It will be appreciated that multiple stages may be used. Larger droplets of oil that may escape the filter (and thus, not fall below in the oil collection area 41) can be trapped by means of a secondary stage filter. At this stage, since the particles have already coalesced and are larger in diameter, conventional methods for trapping can be applied through the use of a secondary fibrous honeycomb filter, or any other type of existing coalescing filters (such as fiber mesh filter, wire mesh filters, pleated paper filters). To form a honeycomb pattern, a plug 44 is provided at alternating input and output channels for the porous substrate 21. This alternate arrangement of plugging creates a set of input channels 21 where and air oil mixture is received, and all gas is forced through a channel wall to be received in an adjacent exhaust channel 25. This honeycomb construction is typically referred to as a wall flow filter. It will be appreciated that several modifications may be made to the positioning of the plugs, sizing up the channels, and arrangements of the honeycomb, as well as shape of channels, thickness of walls, design and arrangement of the checkerboard pattern, arrangement of channels, and overall geometry of the filter.

The honeycomb configuration of the porous substrate provides high surface area for filtration to facilitate coalescence of the admixture stream that improves the effective utilization of filter volume. In this honeycomb configuration, the porous substrate can provide increased effective filtration with a minimum overall filter size. Further, the honeycomb configuration of the porous substrate provides sufficient strength in the filtration material to avoid the telescoping phenomenon seen in conventional pleated paper honeycomb substrates. Accordingly, the honeycomb configuration of the porous substrate is a robust and effective mechanism for filtration and coalescence of admixture streams.

Advantageously, air oil separator 10 efficiently removes oil from the air, and also filters particulate matter from the exhaust gas. Due to the highly effective and efficient removal of oil and particulate matter, the filter may be made relatively small, thereby saving valuable space in engine design. Further, it has been found that filter 10 may be constructed to provide acceptably low back pressures, even when compactly arranged.

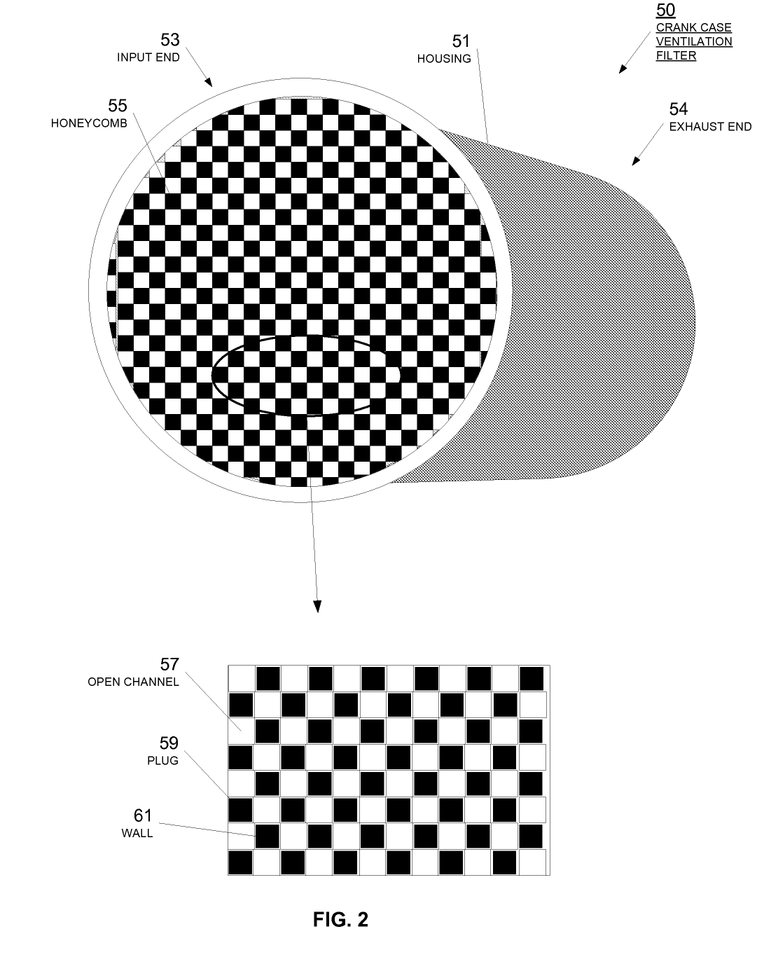

Referring now to FIG. 2, an air oil filter 50 is illustrated. Air oil filter 50 has a housing 51 holding a porous substrate arranged in a honeycomb pattern 55. The porous substrate, in one example, may be a ceramic porous substrate comprising bonded ceramic fibers. The filter 50 has an input end 53 for receiving an air oil admixture, and an exhaust end 54 for exhausting a filtered gas. It will be understood that an oil collection area may be positioned at the input end 53, or in an alternate position, and that design variations, such as the flow direction and inlet position, as well as the location and position of the housing 51, can be made without departing from the scope of the invention. The honeycomb 55 has alternating open channels 57 and closed channels having plugs 59. In this way, the air oil admixture entering any open channel will pass through a wall such as wall 61 as the air moves through the filter. The wall 61 acts to both coalesce oil, and to trap particulate matter from the gas.

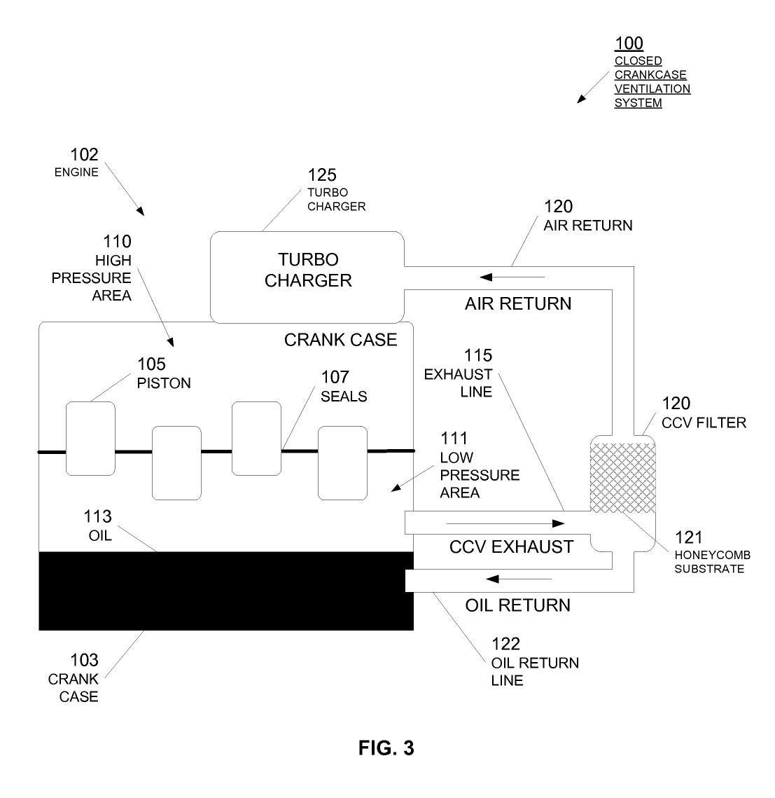

Referring now to FIG. 3, a closed crank case ventilation system 100 is illustrated. Closed crank case ventilation system 100 has an engine 102. Internal combustion engine 102 will not be described in detail, but major components relevant to the filtration system will be described. Engine 102 has a crank case 103 having a set of pistons 105. The pistons are sealed 107 from the crank case 103, however the seals provide an imperfect seal, so the higher-pressure gas from the crank case may escape into the crank case. The crank case 103 also contains a pool of oil 113. The oil 113 is used for lubricating the engine, including the piston and drive mechanism for the engine. The engine gases that escape into the low-pressure area 111 are exhausted through the crank case exhaust line 115. The exhaust line couples to a crank case filter 120, which may be similar to crank case filter 10 described with reference to FIG. 1. Crank case filter 120 is preferably a honeycomb structure having porous walls. These porous walls may be constructed using bonded ceramic fibrous material, with the structure of the wall being defined by ceramic bonds. The exhaust line 115 receives a mixture of exhaust gas and oil, which passes through the honeycomb substrate 121. Oil coalesces in the walls of the honeycomb substrate, and is collected and returned through oil return line 122 to the crank case 103. Air continues through the honeycomb substrate 121, where particulate matter is also captured either on the surface of the walls or inside the thickness of the walls. The air continues through an air return line 121 and may be received into, for example, a turbocharger 125. It will be appreciated the other connections and components may be used in the construction of a closed crank case ventilation system. To ensure the flow of gas in an intended direction, it is presumed that the inlet side will have slightly higher pressure than the outlet side.

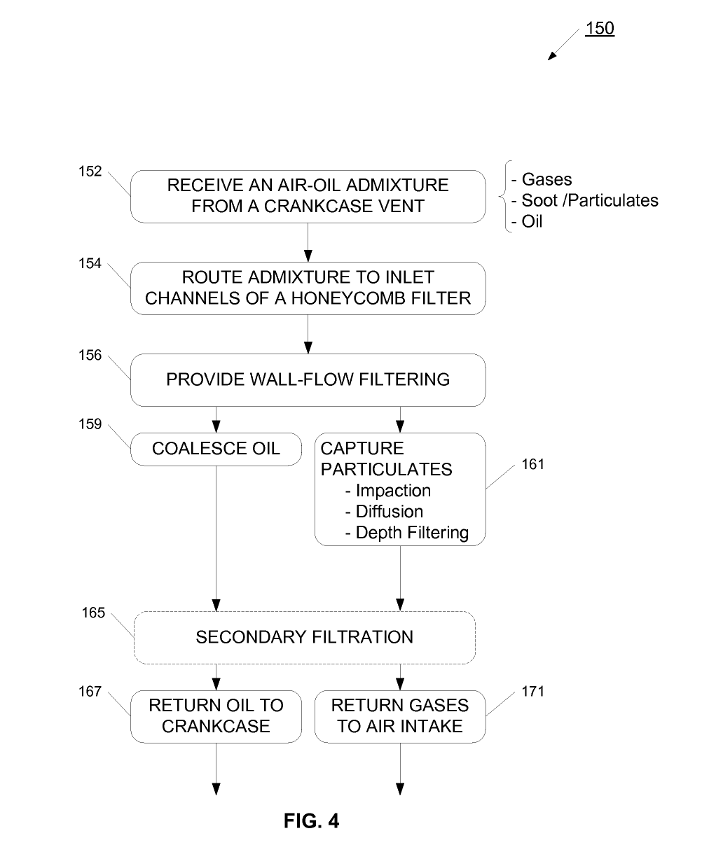

Referring now to FIG. 4, a process for using a crank case filter is illustrated. Process 150 starts with a filter receiving an air oil admixture from a crank case vent as shown in block 152. This air oil admixture may include gases, air, soot, particles, and oil. The admixture is routed to input channels of a honeycomb filter as shown in block 154. The admixture is passed through walls as shown in block 156, thereby providing a wall flow filtering. Oil is coalesced as the admixture passes through the honeycomb as shown in block 159, while soot and other particular matter is captured as shown in block 161. Depending upon the type of soot or particular matter, the particulate matter may be captured through impaction, diffusion, or depth filtering. In some cases, another stage of filtering may be provided as shown in block 165. This secondary filtration may include, for example, another air oil filter separator, or may include additional filtering specific for the oil or gas. In another example, the primary or the secondary or both filters may be coated with catalyst materials for conversion of species entrained in the fluid flow. The oil is returned to the crank case as shown in block 167, and the gases are returned to the engine as shown in block 171. In this way, process 150 operates as a closed crank case system.

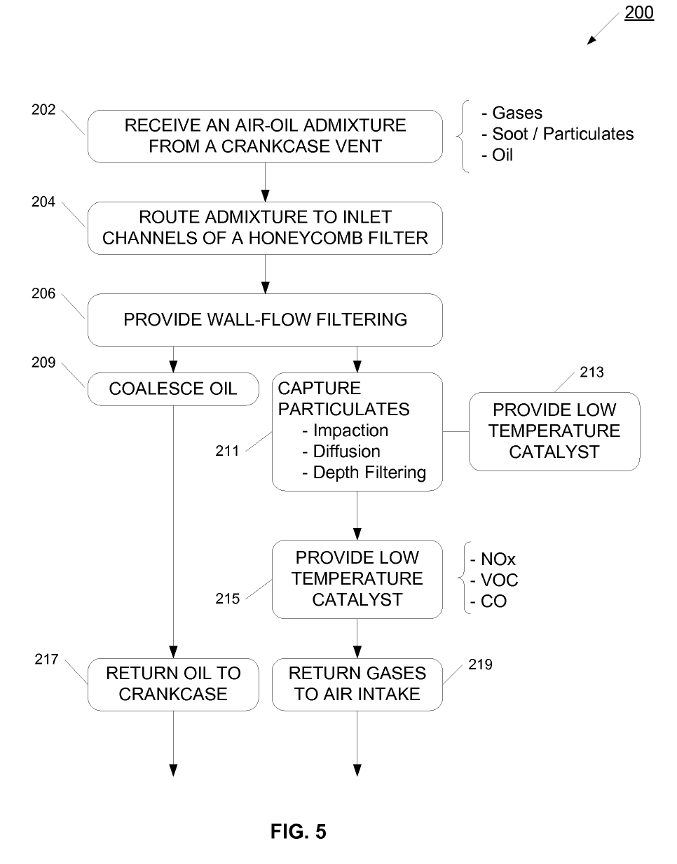

Referring now to FIG. 5, another air oil process is illustrated. Process 200 has a crank case filter receiving an air oil admixture from a crank case as shown in block 202. This gas admixture may include air, exhaust gases, soot, particles, and oil. The admixture is routed to the inlet channels of a honeycomb filter as shown in block 204. The honeycomb filter, as previously described, provides for wall flow filtering as shown in block 206. The wall flow filtering acts to coalesce the oil as shown in block 209. The coalesced oil is returned to the crank case as shown in block 217. The gases are passed through the honeycomb wall, which acts to trap particulates 211 as previously described. A low temperature catalyst may also be provided of the filter as shown in block 215. This low temperature catalyst acts to convert noxious components in the gas to less harmful and less polluting gases. For example, a low temperature catalyst may be provided for converting carbon monoxide to carbon dioxide. The low temperature catalyst may also act to reduce the VOC emissions, as well as provided for NOx reduction. The catalyzed gases may then be returned to the engine as shown in block 219. Alternatively a secondary device, such as microwave discharge, plasma or external heating may also be used to burnoff any volatile or refractory material so the filter can be cleaned via regeneration to the highest possible extent.

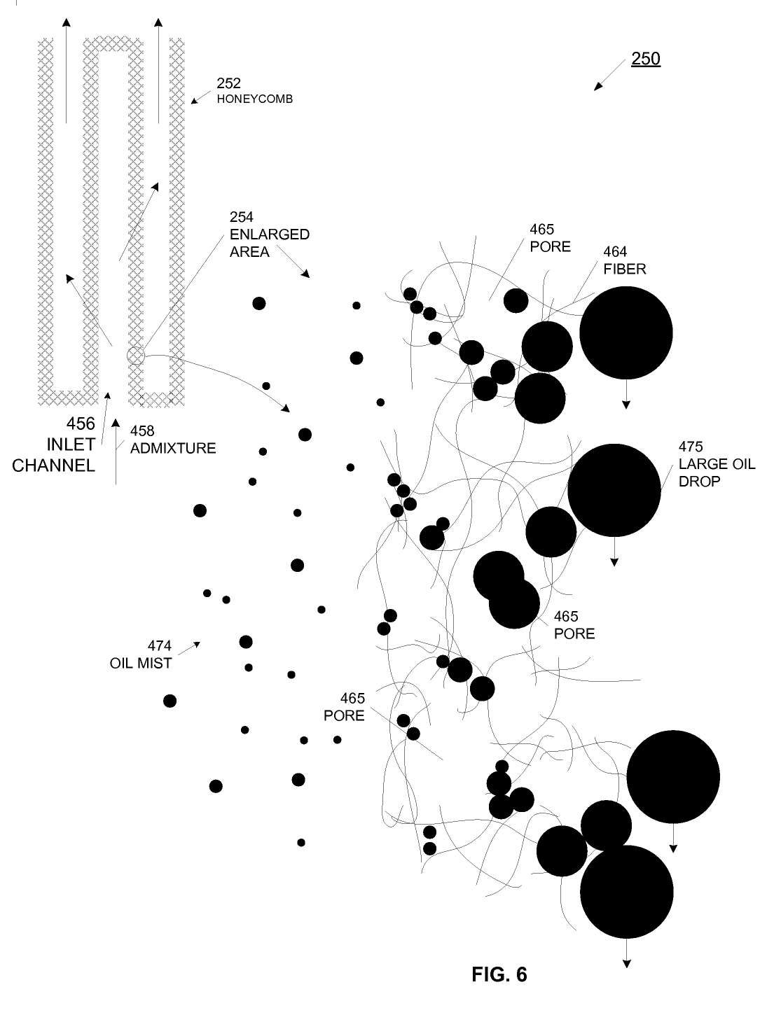

Referring now to FIG. 6, additional detail is illustrated for a crank case filter. Crank case filter portion 250 shows a honeycomb substrate 252 having an inlet channel 456 that receives an admixture 458. The admixture contains a mixture of air and oil. The admixture is received into inlet channel 456 and passes through one or more honeycomb walls. The honeycomb wall is shown with an enlarged area 254. As illustrated, the substrate wall has overlapping and bonded fibers, which may be ceramic fibers. The ceramic fibers are arranged and bonded to construct a rigid filtration media, which is porous to the passage of air, but is able to capture particulate and soot, as well as coalesce oil. The structure of the overlapping and bonded fibers creates small interconnected spaces, or pores, that typically range between 1 and 30 microns, depending on the diameter of the fiber. Sub-micron spaces can be attained through the use of nano-fiber sizes. Further, as the air oil admixture passes through the filter, the oil mist 475 contacts fibers, and begins to coalesce in the pores 465 of the channel walls. Through the coalescing process, oil coalesces into progressively larger drops, until large enough oil drops 475 are created that gravity or other mechanical force causes the oil to move to an oil collection area. In this way, oil may be efficiently removed from an air oil admixture, while enabling air to pass through the honeycomb wall without undue back pressure. It will be appreciated that the thickness of the cell wall, porosity of the cell wall, and sizes and shapes of pores may be adjusted for different removal of requirements.

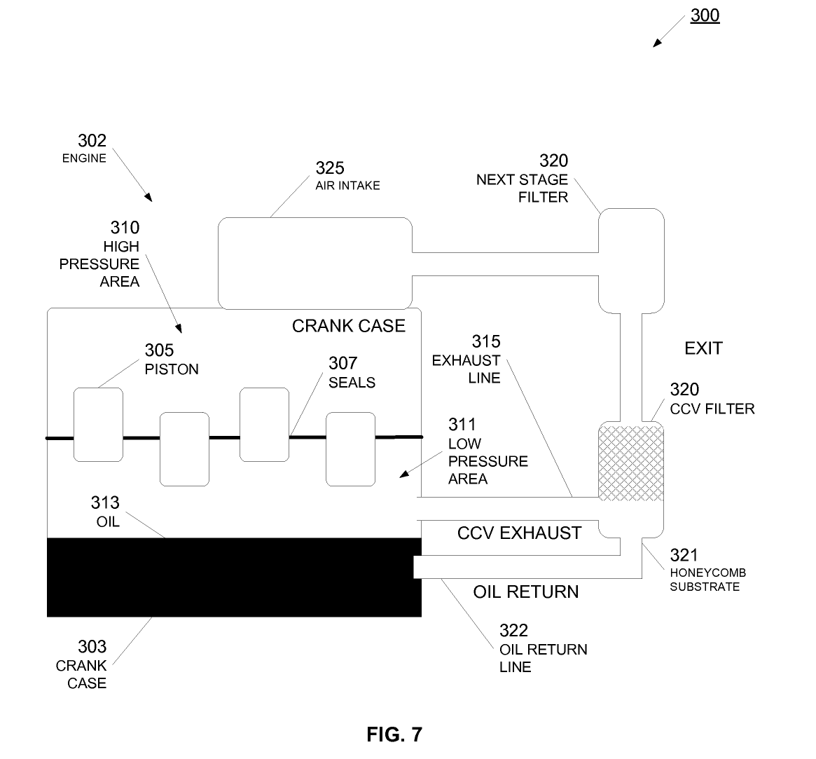

Referring now to FIG. 7, another closed crank case filter system is illustrated. Crank case system 300 has an engine 302 which includes a crank case 303. Pistons 305 have seals to isolate a high pressure area 310 from a low pressure area 311. Although seals 307 provided some isolation between high-pressure area 310 and low pressure area 311, some exhaust gases from high-pressure area 310 escapes into low pressure area 311. Gases that escape into low pressure area 311 mix with oil 313 to form an admixture of air and oil. This air oil admixture is exhausted to exhaust line 315 and received into crank case filter 320. Crank case filter 320 may be similar to filter 10 described with reference to FIG. 1. Crank case filter 320 has a honeycomb substrate 321 as described earlier. As the air oil admixture passes through crank case filter 320, oil is coalesced and returned to the crank case 303 through oil return line 322. Air exiting crank case filter 320 may still contain some amount of oil or particulate matter. The next stage filter 322 is used to further clean the exhaust gas. In one example, the second stage filter 322 is another crank case filter as described with reference to FIG. 1. The diameter of the fibers, the chemical composition of the fibers, the cell density of the substrate, wall thickness, cellular structure, porosity, permeability, or pore size of filter 322, as well as overall dimensions of the filter may be adjusted to trap different size particles, or coalesce a finer mist of oil. For example, the honeycomb substrate 321 of the crank case filter 320 can be composed of mullite fibers, and the second stage filter 320 can be composed of fiberglass. The air exhausted from the next stage filter 322 is returned to the engine 302. In one example, the air is simply returned to an air intake 325, although the air may be returned to a turbocharger, for example.

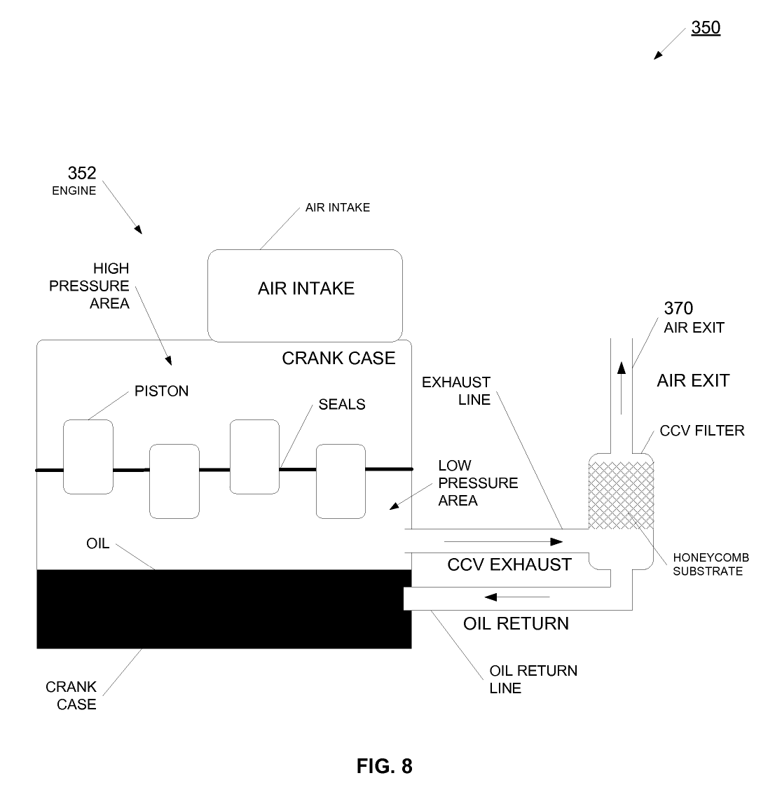

Referring now to FIG. 8, an open crank case filter system 350 is illustrated. System 350 has an engine 352 having a crank case, high-pressure area, low-pressure area, piston, and seals as previously described. An air oil admixture is exhausted through an exhaust line into a honeycomb substrate. The honeycomb substrate may be, for example, a filter 10 as described with reference to FIG. 1. Air passing through the honeycomb substrate has its oil mist coalesced into larger drops, which are collected and returned to the crank case. Particulate matter, such as soot, is also trapped in the honeycomb walls. The air is returned to the atmosphere through an air exit 370. Although less environmentally friendly than previously described closed systems, the open system may be used in some applications, such as for small engines used in gardening equipment.

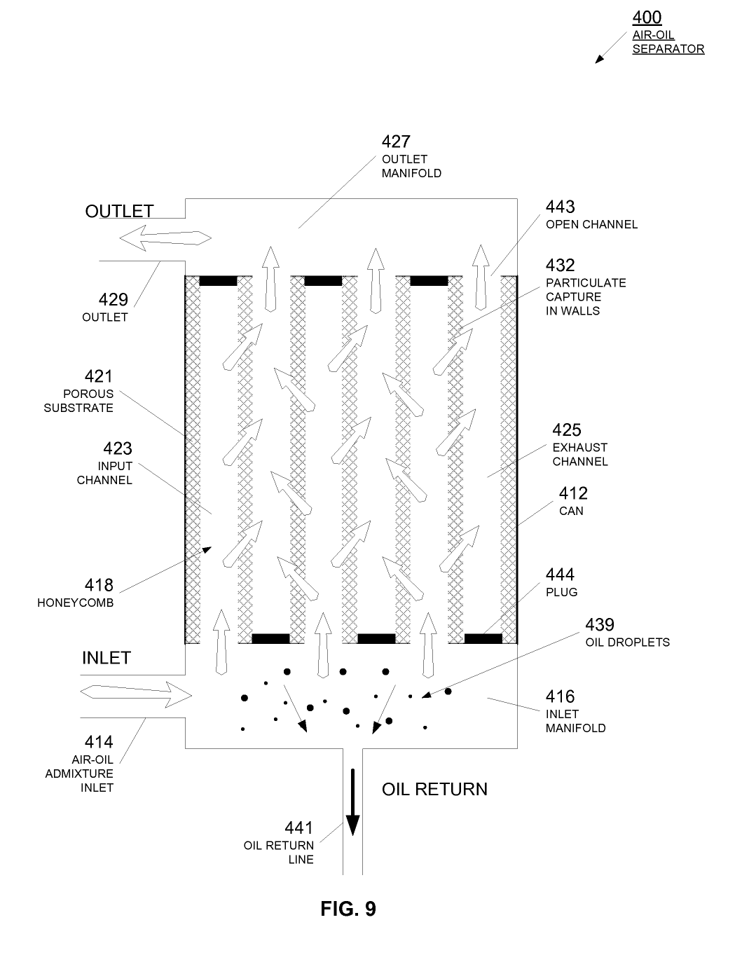

FIG. 9 shows another application for an oil-gas separator. In FIG. 9, the air-oil separator 400 is used as part of an air compression system. Such systems are typically used in industrial applications for generating compressed air, for example, to operate pneumatic equipment. A compressor is a device used to take air at atmospheric pressure and increase its pressure for pneumatic purposes. In this process, the compression system injects a fine mist of oil into the compressed air. This compressed air, if the oil were not removed, might damage pneumatic equipment. Therefore, it is important to remove oil from the compressed air. Trapping the oil and recycling it also reduces the oil loss and extends the time before re-filling of oil by operator is required. The air oil separator 400 has an air oil admixture inlet 414 for receiving compressed air. The compressed air has a mixture of air and oil, which is received into the input manifold 416. The compressed air is received into the honeycomb 418, and more particularly into the input channels 423. The air oil admixture is passed through honeycomb walls into the exhaust channels 425. Input channels 423 are separated from exhaust channels 425 using plugs 444. In this way, a wall flow filtering system is designed. As the air oil admixture passes through the honeycomb walls, the oil coalesces in the porous substrate 421 of the wall, causing oil droplets 439 to fall into the oil return area and be returned through an oil return line 441. The compressed air also passes through the wall, where particulate matter 432 may be captured on the surface of the wall or inside the thickness of the wall. The clean air exits output channel 443 and is received into output 427. The outlook manifold 427 then couples to attached pneumatic equipment through its output 429. Advantageously, the air oil separator 400 is able to efficiently remove particulate matter and oil from compressed pneumatic air, while causing little reduction in air pressure. Further, the ceramic honeycomb structure provides high efficiency, enabling a relatively small filter 400 to be used. Alternatively, a second stage filter can be used to capture any material, oil droplets, or particulate matter that may escape the porous substrate 421. For example, a secondary stage filter, as described above with regard to other embodiments, can be used as a separate filter, or within the outlet port 429 of the separator 400.

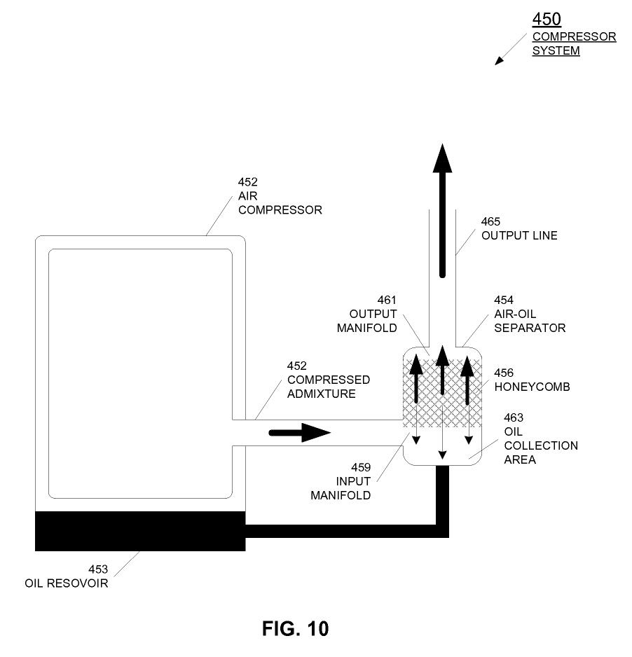

Referring now to FIG. 10, and overall structure for a compressor system 450 is illustrated. A compressor system 450 has an air compressor 452 having an oil reservoir 453. As the air compressor operates to compress air, the compressor apparatus injects a fine mist of oil into the compressed air. In this way, a compressed admixture 452 of air and oil is generated by the air compressor. The compressed admixture 452 is received into an air oil separator 454. The air oil separator 454 may be, for example, similar to air oil separator 400 discussed with reference to FIG. 9. The air oil admixture passes through a honeycomb substrate 456, so that oil coalesces into an oil collection area 463 and is returned to the oil reservoir 453, and clean air is received into an output manifold 461. The clean air has also had particular matter removed. The cleaned air is then sent through output line 465 to attached pneumatic equipment.

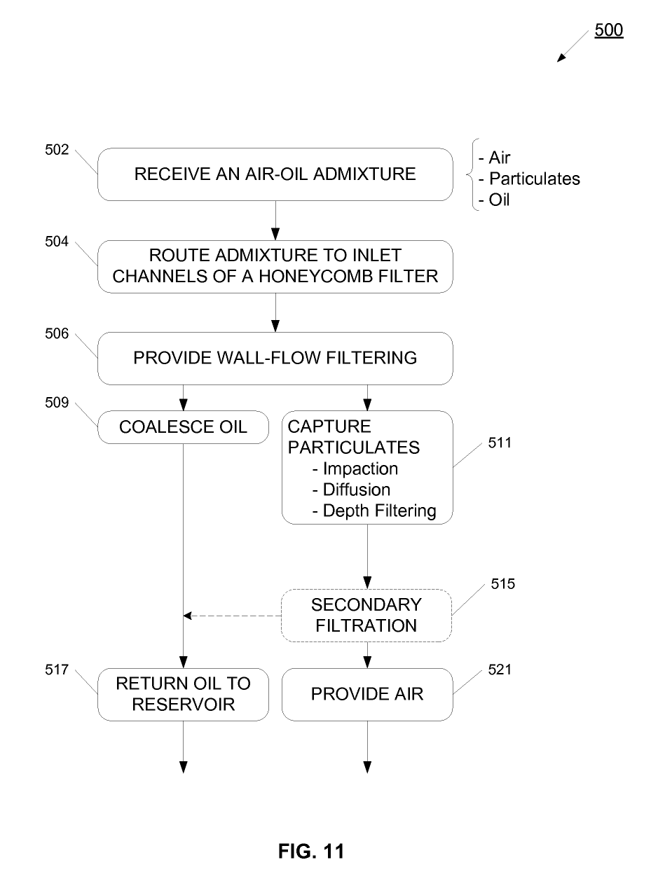

Referring now to FIG. 11, a process for removing oil is illustrated. Process 500 has a compressor generating an air oil admixture as shown in block 502. The admixture may include air, particulate matter (debris such as soot, dust, engine wear particles, etc), and lubrication and coolant oil. The air oil admixture is routed into a set of inlet channels in a honeycomb filter as shown in block 504. The honeycomb filter is preferably constructed of bonded ceramic fibers, thereby providing highly porous ceramic walls. The filter is further constructed as a wall flow filter, such that alternate channels are plugged. Since the filter is a wall flow filter as shown in block 506, the air oil admixture is routed through the highly porous walls. Oil is coalesced in the wall as shown in block 519, which then may be returned to an oil reservoir as shown in block 517. As the air flows through the porous wall, particulate matter may also be captured. The particular matter may be captured through impaction, diffusion, or depth filtering as shown in block 511. In some applications, a secondary filtration may be used to further clean particulate matter from the air, or remove additional oil as shown in block 515. The air is then provided to pneumatic equipment as shown in block 521.

The filters of the present invention can be used to separate oil and particulate matter from air flow in stationary applications, for example, power generation, pumping equipment, and the like, and mobile applications over land, sea, and air, including, but not limited to automobiles, motorcycles, and farm and commercial vehicles.

While particular preferred and alternative embodiments of the present intention have been disclosed, it will be apparent to one of ordinary skill in the art that many various modifications and extensions of the above described technology may be implemented using the teaching of this invention described herein. All such modifications and extensions are intended to be included within the true spirit and scope of the invention as discussed in the appended claims.

What is claimed is:

1. A gas-liquid separator, comprising:
an inlet for receiving a mixture of gas and liquid;
bonded fibers forming a porous substrate;
channels in the porous substrate forming an extruded honeycomb;
an inlet manifold arranged to direct the gas-liquid mixture into the channels;
an outlet manifold arranged to receive gas that has flowed through the porous substrate; and
a liquid collection area for receiving oil that has coalesced in the porous substrate.

2. The gas-liquid separator according to claim 1, wherein the bonded fibers comprise ceramic fibers.

3. The gas-liquid separator according to claim 1, wherein the gas is air and the liquid is oil.

4. The gas-liquid separator according to claim 1, wherein the bonds are inorganic bonds or organic bonds.

5. The gas-liquid separator according to claim 1, further comprising:
a set of inlet channels in the porous substrate;
a set of outlet channels in the porous substrate and arranged in an alternating pattern with the set of inlet channels; and
a porous wall between adjacent inlet channels and outlet channels.

6. The gas-liquid separator according to claim 1, wherein the air received in the outlet manifold also comprises oil, and the outlet manifold couples to a second stage filter.

7. The gas-liquid separator according to claim 1, wherein the porous substrate is constructed as a wall-flow filter.

8. The gas-liquid separator according to claim 1, wherein the bonded fibers comprise sintered bonds.

9. The gas-liquid separator according to claim 1, wherein the bonded fibers comprise solid state, crystalline, or glass bonds.

10. The gas-liquid separator according to claim 1, wherein the porous substrate comprises an open pore network formed by bonded fibers.

11. The gas-liquid separator according to claim 1, wherein the porous substrate has a porosity in the range of about 50% to about 85%.

12. The gas-liquid separator according to claim 1, wherein the inlet is a crank case vent (CCV) inlet for receiving the mixture of air and oil.

13. The gas-liquid separator according to claim 1, further comprising a catalytic material on the porous substrate.

14. The gas-liquid separator according to claim 1, wherein the bonded fibers further comprise fibers having a diameter between 0.2 microns and 10 microns.

15. The gas-liquid separator according to claim 1, wherein the bonded fibers further comprise fibers having a diameter between 1 microns and 25 microns.

16. The gas-liquid separator according to claim 1, wherein the bonded fibers further comprise fibers having a diameter less than 0.2 microns.

17. The gas-liquid separator according to claim 2, wherein the ceramic fibers are composed of alumina and silica.

18. The gas-liquid separator according to claim 2, wherein the ceramic fibers are composed of mullite.

19. The gas-liquid separator according to claim 2, wherein the ceramic fibers are composed of alumina, zirconia, and silica.

20. A crank case ventilation system, comprising:
a crank case vent on an engine;
an inlet line connecting the crank case vent to a crank case filter, the crank case filter further comprising:
an admixture inlet for receiving a mixture of air and oil;
a porous ceramic substrate;
an inlet manifold arranged to direct the admixture into the porous ceramic substrate;
an outlet manifold arranged to receive air that has flowed through the porous ceramic substrate; and
an oil collection area for receiving oil that has coalesced in the porous ceramic substrate;
an exhaust line connected to the crank case filter; and
an oil return line.

21. The crank case ventilation system according to claim 20, wherein the exhaust line is constructed to connect to an air intake for the engine.

22. The crank case ventilation system according to claim 20, wherein the exhaust line is constructed to connect to a next stage filter.

23. The crank case ventilation system according to claim 20, wherein the exhaust line is constructed to exhaust to the atmosphere.

24. The crank case ventilation system according to claim 20, wherein the oil return line is constructed to connect to the crank case of the engine.

25. A method of separating a liquid from a gas, comprising:
receiving a gas-liquid admixture;
routing the admixture to input channels of an extruded porous substrate;
passing the gas through porous walls to outlet channels;
coalescing at least some of the liquid in the porous walls;
collecting the coalesced liquid in a liquid collection area; and
exhausting the gas from the outlet channels.

26. The method according to claim 25, wherein the porous substrate comprises bonded fibers.

27. The method according to claim 25, wherein the step of routing the admixture includes routing the admixture to input channels arranged in a honeycomb.

28. The method according to claim 27, wherein the fibers comprise ceramic fibers.

29. The method according to claim 25, wherein the gas is air and the liquid is oil.

30. The method according to claim 25, further comprising the step of trapping airborne particles in the porous walls.

31. The method according to claim 25, further comprising the step of exhausting the gas to a next stage filter, to an air intake for an engine, or to the atmosphere.

32. The method according to claim 25, wherein the liquid is oil, and further comprising the step of returning the collected oil to an oil reservoir or to an engine crank case.

33. The method according to claim 25, wherein the liquid in the gas-liquid admixture is in the form of droplets.

34. The method according to claim 25, wherein the gas-liquid admixture further comprises particles.

35. The method according to claim 25, wherein the gas exhausted from the output channels comprises coalesced droplets of liquid, and the method further comprises routing the gas exhausted from the output channels to a second stage filter.

36. An air-oil separator, comprising:
an inlet for receiving a mixture of air and oil;
bonded ceramic fibers forming a porous ceramic substrate;
channels in the porous ceramic substrate forming an extruded honeycomb;
an inlet manifold arranged to direct the air-oil mixture into the channels;
an outlet manifold arranged to receive air that has flowed through the porous ceramic substrate; and
an oil collection area for receiving oil that has coalesced in the porous ceramic substrate.
